(19) United States
(12) Patent Application Publication
(10) Pub. No.: US 2026/0095009 A1
(43) Pub. Date: Apr. 2, 2026

(54) METHOD OF MANUFACTURING CONNECTOR

(71) Applicant: SUMITOMO ELECTRIC INDUSTRIES, LTD., Osaka (JP)

(72) Inventors: Masahiro MATSUMOTO, Osaka (JP); Masamichi YAMAMOTO, Osaka (JP)

(73) Assignee: SUMITOMO ELECTRIC INDUSTRIES, LTD., Osaka (JP)

(21) Appl. No.: 19/343,315

(22) Filed: Sep. 29, 2025

(30) Foreign Application Priority Data
Oct. 1, 2024 (JP) 2024-172808

(51) Int. Cl. H01R 43/02

(52) U.S. Cl. CPC H01R 43/0249; H01R 43/0256; H01R 43/0263

(57) ABSTRACT

A method of manufacturing a connector, in which a plurality of central conductors each exposed at an end portion of an insulated wire are soldered, in a one-to-one correspondence, to a plurality of connectable portions arranged side by side on a substrate, includes placing the plurality of central conductors in a one-to-one correspondence with the plurality of connectable portions at each of which solder is disposed and pressing the plurality of central conductors placed in the placing against the plurality of connectable portions. In the pressing, the plurality of central conductors are heated and pressed by using a pressing jig. The pressing jig includes a cushion portion and a heat-conductive portion sequentially in a direction in which the pressing jig presses the plurality of central conductors.

### TECHNICAL FIELD

The present disclosure relates to a method of manufacturing a connector. The present application claims priority based on Japanese Patent Application No. 2024-172808 filed in the Japan Patent Office on October 1, 2024, and the entire contents of the Japanese patent application are incorporated herein by reference.

### BACKGROUND

Japanese Unexamined Patent Application Publication No. 2016-92040 (Patent Document 1) discloses a connector in which a plurality of connectable portions arranged side by side on a substrate are soldered, in a one-to-one correspondence, to central conductors exposed at end portions of insulated wires.

### SUMMARY

A method of manufacturing a connector according to the present disclosure is a method of manufacturing a connector in which a plurality of central conductors each exposed at an end portion of an insulated wire are soldered, in a one-to-one correspondence, to a plurality of connectable portions arranged side by side on a substrate, the method including placing the plurality of central conductors in a one-to-one correspondence with the plurality of connectable portions at each of which solder is disposed, and pressing the plurality of central conductors placed in the placing against the plurality of connectable portions. In the pressing, the plurality of central conductors are heated and pressed by using a pressing jig. The pressing jig includes a cushion portion and a heat-conductive portion sequentially in a direction in which the pressing jig presses the plurality of central conductors.

### BRIEF DESCRIPTION OF THE DRAWINGS

FIG. 1 is a flowchart illustrating a method of manufacturing a connector according to an embodiment of the present disclosure.

FIG. 2 is a plan view illustrating a placing step in the manufacturing method illustrated in FIG. 1.

FIG. 3 is a cross-cross-sectional view taken along line III-III in FIG. 2.

FIG. 4 is a plan view illustrating a state in which a pressing jig is placed on a plurality of central conductors in a pressing step of the manufacturing method illustrated in FIG. 1.

FIG. 5 is a cross-cross-sectional view taken along line V-V, illustrating a state before pressing using the pressing jig in the pressing step of the manufacturing method illustrated in FIG. 1.

FIG. 6 is a cross-sectional view illustrating a state in which the plurality of central conductors are pressed by the pressing jig in the pressing step of the manufacturing method illustrated in FIG. 1.

FIG. 7 is a cross-sectional view illustrating a state in which the plurality of central conductors are heated by the pressing jig in the pressing step of the manufacturing method illustrated in FIG. 1.

FIG. 8 is a cross-sectional view illustrating a connector manufactured by the manufacturing method illustrated in FIG. 1.

FIG. 9 is a cross-sectional view illustrating a modification of the connector manufactured by the manufacturing method according to the present disclosure.

FIG. 10 is a cross-sectional view corresponding to FIG. 5, illustrating a first modification of the pressing jig used in the manufacturing method according to the present disclosure.

FIG. 11 is a cross-sectional view corresponding to FIG. 5, illustrating a second modification of the pressing jig used in the manufacturing method according to the present disclosure.

FIG. 12 is a cross-sectional view corresponding to FIG. 5, illustrating a third modification of the pressing jig used in the manufacturing method according to the present disclosure.

FIG. 13 is a cross-sectional view corresponding to FIG. 5, illustrating a fourth modification of the pressing jig used in the manufacturing method according to the present disclosure.

FIG. 14 is a plan view corresponding to FIG. 4, illustrating a fifth modification of the pressing jig used in the manufacturing method according to the present disclosure.

FIG. 15 is a cross-sectional view taken along line XV-XV, illustrating a sixth modification of the pressing jig used in the manufacturing method according to the present disclosure.

FIG. 16 is a plan view illustrating a modification of a heat-conductive portion used in the manufacturing method according to the present disclosure.

FIG. 17 is a plan view illustrating another modification, different from that illustrated in FIG. 16, of the heat-conductive portion used in the manufacturing method according to the present disclosure.

FIG. 18 is a plan view illustrating another modification, different from those illustrated in FIG. 16 and FIG. 17, of the heat-conductive portion used in the manufacturing method according to the present disclosure.

### DETAILED DESCRIPTION

In recent years, with the trend toward reduction in the diameters of insulated wires and minimizing the areas of connectable portions, the amount of solder that can be applied to each connectable portion has become limited. As a result, there is a growing demand for technologies for reliably soldering the central conductor to a connectable portion.

Patent Literature 1 describes that a core wire of a coaxial cable is placed on an upper surface of a conductive bonding portion in a state where solder is applied to the upper surface and that the conductive bonding portion, the solder, and the core wire are covered with a light-transmissive sheet. Patent Literature 1 describes that the light-transmissive sheet includes an adhesive layer that adheres to the core wire and the solder. Patent Literature 1 describes that light is irradiated toward the light-transmissive sheet, which has been disposed in such a manner that the core wire does not deform or move in either the vertical direction or the horizontal direction, so as to cause the solder to melt by light energy, thereby soldering the conductive bonding portion and the core wire together.

However, in the technology described in Patent Literature 1, solder bonding can only be achieved on the peripheral surface of the lower half of the core wire, making it difficult to sufficiently enhance the bonding strength between the core wire and the conductive bonding portion.

The present disclosure has been made in view of the above situation, and it is an object of the present disclosure to provide a method of manufacturing a connector capable of enhancing the bonding strength between a central conductor and a connectable portion.

A method of manufacturing a connector according to an aspect of the present disclosure, can enhance the bonding strength between a central conductor and a connectable portion.

First, embodiments of the present disclosures will be listed and described.

(1) A method of manufacturing a connector according to the present disclosure is a method of manufacturing a connector in which a plurality of central conductors each exposed at an end portion of an insulated wire are soldered, in a one-to-one correspondence, to a plurality of connectable portions arranged side by side on a substrate, the method including placing the plurality of central conductors in a one-to-one correspondence with the plurality of connectable portions at each of which solder is disposed and pressing the plurality of central conductors placed in the placing against the plurality of connectable portions. In the pressing, the plurality of central conductors are heated and pressed by using a pressing jig. The pressing jig includes a cushion portion and a heat-conductive portion sequentially in a direction in which the pressing jig presses the plurality of central conductors.

In the method of manufacturing the connector, since the pressing jig includes the cushion portion and the heat-conductive portion sequentially in the direction in which the pressing jig presses the plurality of central conductors, the plurality of central conductors can be pressed with uniform pressure when the pressing jig is pressed against the plurality of central conductors. As a result, the method of manufacturing the connector enables soldering in a state in which the plurality of central conductors are in uniform close contact with the plurality of connectable portions. In addition, since the pressing jig includes the heat-conductive portion, the method of manufacturing the connector enables soldering between the plurality of central conductors and the plurality of connectable portions while heating regions of the plurality of central conductors, the regions being located on the side opposite to the side on which the plurality of connectable portions are located. As a result, the height of each solder fillet can be increased, thereby increasing the contact areas among the plurality of central conductors, the plurality of connectable portions, and their respective solder fillets. Therefore, the method of manufacturing the connector can enhance the bonding strength between the connectable portions and their respective central conductors.

(2) In (1), the cushion portion and the heat-conductive portion may be deformed in the pressing to conform to shapes of the plurality of central conductors. According to this aspect, the plurality of central conductors and their respective connectable portions can be more reliably soldered together while the plurality of central conductors are positioned with respect to the plurality of connectable portions. In addition, according to this aspect, even in the case where there are variations in the heights of solder bonding surfaces (surfaces that are opposite to surfaces to be arranged on the substrate) of the plurality of connectable portions, the plurality of central conductors and the plurality of connectable portions can be reliably soldered together.

(3) In (1) or (2), the pressing jig may further include a pressing portion disposed on a surface of the cushion portion, the surface being located on a side opposite to the heat-conductive portion. According to this aspect, the cushion portion and the heat-conductive portion can be easily and reliably pressed against the plurality of central conductors.

(4) In any one of (1) to (3), in the pressing, the plurality of central conductors may be pressed in a non-adhesive manner by the heat-conductive portion. According to this aspect, the height of each of the solder fillets can be more easily increased.

(5) In any one of (1) to (4), in the pressing, the heat-conductive portion may not be brought into contact with the substrate. According to this aspect, the height of each of the solder fillets can be more easily increased.

(6) In any one of (1) to (5), the heat-conductive portion nay include a heating target region projecting beyond the cushion portion in plan view. According to this aspect, the heat-conductive portion can be easily heated.

(7) In (6), the heating target region may project in an axial direction of the plurality of central conductors. According to this aspect, the plurality of central conductors and the solder disposed at the plurality of connectable portions can be uniformly heated via the heat-conductive portion. As a result, the plurality of central conductors and the plurality of connectable portions can easily be soldered together with uniform bonding strength.

(8) In (3), the heat-conductive portion may be bent to be in contact with the pressing portion, and the heat-conductive portion may be heated by heat from the pressing portion. According to this aspect, for example, by integrating the pressing portion and the heat source, the installation area of an apparatus can be reduced, thereby achieving cost reduction. In addition, the temperature ramp-up rate and the maximum attainable temperature of the plurality of central conductors are more readily increased, making it easier to improve the manufacturing efficiency of the connector.

(9) In any one of (1) to (8), the heat-conductive portion may have a solder-repellent surface configured to come into contact with the plurality of central conductors. According to this aspect, the solder can be prevented from being bonded to the heat-conductive portion. As a result, the plurality of central conductors and the plurality of connectable portions can be easily and reliably soldered together.

(10) In any one of (1) to (9), the cushion portion may contain rubber, a soft resin, or an elastomer as a main component, and an average thickness of the cushion portion may be 30 µm to 1000 µm. According to this aspect, the plurality of central conductors can be more easily pressed with uniform pressure.

(11) In any one of (1) to (10), the heat-conductive portion may be a film containing a metal as a main component. According to this aspect, excessive deformation of the cushion portion can be suppressed by the heat-conductive portion. As a result, it is possible to prevent a space in which the solder flows from becoming insufficient due to excessive deformation of the cushion portion.

(12) In any one of (1) to (11), the heat-conductive portion may have a hole, a slit, or a notch in a region thereof located above the cushion portion. According to this aspect, the heat-conductive portion can be made more deformable.

(13) In any one of (1) to (12), the connector may include, as the plurality of central conductors, one or a plurality of first central conductors each having a first average diameter, and one or a plurality of second central conductors each having a second average diameter smaller than the first average diameter. According to the method of manufacturing the connector, even in a case where the plurality of central conductors include central conductors having different diameters, the plurality of connectable portions and the plurality of central conductors can be easily soldered together.

Note that, in the present disclosure, the term "soft resin" refers to a resin that undergoes compressive deformation in response to an external force. The term "average thickness" refers to the average value of thicknesses measured at any ten positions. The term "main component" refers to a component having the highest content on a mass basis, and refers to, for example, a component having a content of 50 mass% or more. In the present disclosure, when the term "metal" is simply used, it refers to a concept including alloys. The term "diameter" refers to the diameter of a true circle having the same area. The term "average diameter" refers to the average value of diameters measured at any ten positions. In the present disclosure, when the term "on" is simply used, it refers to both direct contact and indirect contact. For example, in phrases such as "on the cushion portion" or "on a surface of the cushion portion located on the side opposite to the side on which the heat-conductive portion is disposed", both direct placement on the cushion portion and indirect placement on the cushion portion with another member interposed therebetween are included.

In the present disclosure, the term "press" refers to pressing one object against another. For example, a phrase "a pressing jig presses a central conductor" includes various pressing manners such as pressing the pressing jig against the central conductor from the side opposite to the central conductor, pressing the pressing jig against the central conductor by reducing pressure, pulling the pressing jig toward the central conductor, and pressing the central conductor against the pressing jig.

Preferred embodiments of the present disclosure will be described below with reference to the drawings. Note that, regarding the numerical values described in the present specification, it is possible to adopt only one of upper or lower limits described herein, or to freely combine the upper and lower limits. In the present specification, all combinable numerical ranges are described. In addition, the drawings are schematic and may not exactly reflect the actual shapes, dimensions, or proportions. In the present disclosure, the terms "first" and "second" are for distinguishing components referred to with these terms, and are not intended to limit the number, order, priority, and the like.

### First Embodiment

### Method of Manufacturing Connector

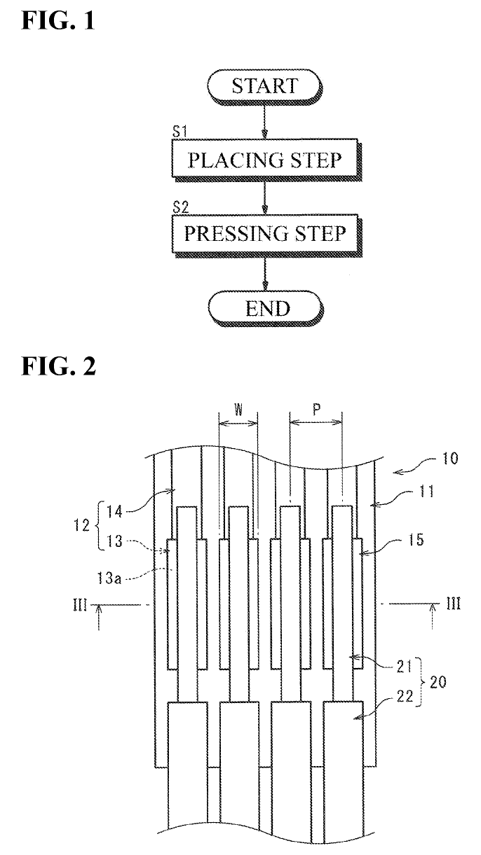

A method of manufacturing a connector according to one aspect of the present disclosure (hereinafter also simply referred to as "the present manufacturing method") is a method of manufacturing a connector in which central conductors each of which is exposed at a distal end portion of a corresponding one of insulated wires are soldered, in a one-to-one correspondence, to a plurality of connectable portions that are arranged on a substrate. As illustrated in FIG. 1, the present manufacturing method includes a placing step S1 of placing the central conductors in a one-to-one correspondence with the connectable portions at each of which solder is disposed and a pressing step S2 of pressing the plurality of central conductors, which have been placed in the placing step S1, against the plurality of connectable portions. In the present manufacturing method, the plurality of central conductors are heated and pressed by a pressing jig in the pressing step S2. The pressing jig includes a cushion portion and a heat-conductive portion in this order in a direction in which the plurality of central conductors are pressed.

In the present manufacturing method, since the pressing jig includes the cushion portion and the heat-conductive portion in this order in the direction in which the plurality of central conductors are pressed, the plurality of central conductors can be pressed with uniform pressure when the pressing jig is pressed against the plurality of central conductors. As a result, the present manufacturing method enables soldering in a state in which the plurality of central conductors are in uniform close contact with the plurality of connectable portions. In addition, since the pressing jig includes the heat-conductive portion, the present manufacturing method enables soldering between the plurality of central conductors and the plurality of connectable portions while heating regions of the plurality of central conductors, the regions being located on the side opposite to the side on which the plurality of connectable portions are located. In other words, according to the present manufacturing method, during solder melting, a temperature gradient is formed in each of the plurality of central conductors from the side closer to the heat-conductive portion toward the side closer to the plurality of connectable portions. As a result, movement of the molten solder is promoted, and the height of each solder fillet can be increased, thereby increasing the contact areas among the plurality of central conductors, the plurality of connectable portions, and their respective solder fillets. Therefore, the present manufacturing method can enhance the bonding strength between the connectable portions and their respective central conductors.

The present manufacturing method can flexibly accommodate various thicknesses and shapes of substrates, and thus, for example, it is possible to omit measurement of the thickness of a substrate, to reduce the time taken to determine manufacturing conditions, and to omit changing the conditions. As a result, manufacturing cost can be reduced.

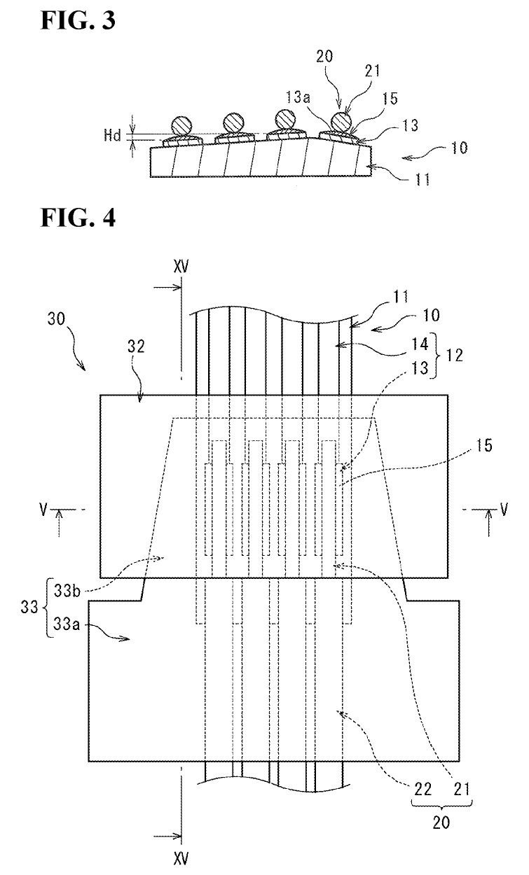

In the present manufacturing method, the central conductors exposed to the outside from their respective insulated wires are soldered, in a one-to-one correspondence, to the plurality of connectable portions arranged on the substrate. Prior to describing each step of the present manufacturing method, examples of objects to be connected to each other by the present manufacturing method will be described first with reference to FIG. 2 and FIG. 3. In the present embodiment, a printed circuit board 10 and insulated wires 20 are connected to each other. The printed circuit board 10 includes a substrate 11 and pad portions 13 that are arranged on the substrate 11 so as to serve as connectable portions, and the insulated wires 20 include central conductors 21 exposed from insulating layers 22.

### Printed Circuit Board

The printed circuit board 10 includes the substrate 11 and a conductive pattern 12 that is disposed on the substrate 11. The conductive pattern 12 includes the plurality of pad portions 13 and wiring portions 14 that extend continuously from their respective pad portions 13. In the conductive pattern 12, the plurality of pad portions 13 are arranged side by side. Each of the pad portions 13 may have a structure in which the corresponding wiring portion 14 is widened in a width direction. In FIG. 2 and FIG. 3, each of the pad portions 13 has a rectangular shape when viewed in plan view, with long sides parallel to the direction in which the corresponding wiring portion 14 extends and short sides perpendicular to these long sides. The rest of the structure of the printed circuit board 10 is not particularly limited as long as it includes the substrate 11 and the plurality of pad portions 13. For example, each of the pad portions 13 may be directly laminated on the substrate 11 or indirectly laminated on the substrate 11 with another layer interposed therebetween. Although the number of the pad portions 13 is not particularly limited, the number may be, for example, two or five as a lower limit. In addition, the number of the pad portions 13 may be 150 or 50 as an upper limit. Even when the number of the pad portions 13 falls within the above-mentioned range, the present manufacturing method enables reliable soldering of the central conductors 21 to the pad portions 13 in a one-to-one correspondence. Note that, in the present disclosure, the term "plan view" refers to a view in a direction normal to a substrate.

The substrate 11 has an insulating property. The substrate 11 may or may not have flexibility. In the case where the substrate 11 has flexibility, a main component thereof may be, for example, a polyimide, a polyethylene terephthalate, a liquid crystal polymer, or a fluororesin. In the case where the substrate 11 does not have flexibility, a main component thereof may be, for example, a glass epoxy, a paper phenol, a paper epoxy, a glass composite, or glass. The printed circuit board 10 may be a flexible printed circuit board, may be a rigid printed circuit board, or may be a rigid-flex printed circuit board.

For example, each of the pad portions 13 is provided in such a manner as to be continuous with the corresponding wiring portion 14. The pad portions 13 are exposed on the substrate 11. The pad portions 13 have electrical conductivity. For example, each of the pad portions 13 may contain copper or gold as its main component. The surfaces of the pad portions 13 may be subjected to plating treatment such as tin plating or gold plating. Each of the pad portions 13 may be a laminate including an electroplated layer. Each of the pad portions 13 may have a two-layer structure formed of an electrically-conductive underlayer formed by, for example, sputtering or the like and an electroplated layer. Alternatively, each of the pad portions 13 may have a three-layer structure formed of an electrically-conductive underlayer, an electroless plated layer, and an electroplated layer. The materials of the electrically-conductive underlayer, the electroless plated layer, and the electroplated layer may be the same as each other or different from each other.

Each of the pad portions 13 has a top surface 13a that is soldered to a corresponding one of the central conductors 21. The top surface 13a includes a flat portion parallel to the substrate 11. A solder portion 15 is formed on the top surface 13a. The solder portion 15 may be formed of, for example, a solder paste. The solder portion 15 is, for example, printed on the top surface 13a. As a method of printing the solder portion 15, a commonly known method can be employed, and for example, screen printing may be used. The solder portion 15 contains solder particles and flux. The type of solder contained in the solder portion 15 is not particularly limited and may be, for example, a lead-free solder such as SnAgCu alloy, SnZnBi alloy, SnAgInBi alloy, SnBi alloy, SnBiAg alloy, SnBiCuNi alloy, SnZn alloy, or InSnAg alloy.

The lower limit of an average width W of the pad portions 13 may be 15 μm or may be 30 μm from the standpoint of ensuring reliable soldering between the pad portions 13 and the central conductors 21. On the other hand, the upper limit of the average width W may be 250 μm or may be 200 μm in consideration of demands such as reduction in the size of the printed circuit board 10. In the case where the average width W is the above-mentioned upper limit or less, increasing the contact areas between the central conductors 21 and solder fillets may become important for reliable soldering between the pad portions 13 and the central conductors 21. Regarding this, the present manufacturing method allows the height of each solder fillet to be increased, thereby enabling reliable soldering between the pad portions 13 and the central conductors 21. Note that the term "average width" refers to the average value of widths measured at any five positions.

The lower limit of an average pitch P of the pad portions 13 may be 35 μm or may be 50 μm from the standpoint of preventing solder bridge formation and ensuring reliable soldering between the pad portions 13 and the central conductors 21. On the other hand, the upper limit of the average pitch P may be 550 μm, may be 300 μm, may be 200 μm, or may be 100 μm from the standpoint of increasing wiring density and reducing the size of the printed circuit board 10. In the case where the average pitch P is the above-mentioned upper limit or less, increasing the contact areas between the central conductors 21 and the solder fillets may become important for avoiding solder bridge formation while achieving reliable soldering between the pad portions 13 and the central conductors 21. Regarding this, the present manufacturing method allows the height of each solder fillet to be increased, thereby enabling reliable soldering between the pad portions 13 and the central conductors 21. Note that the term "pitch" of the pad portions refers to the distance between the central axes of two adjacent ones of the pad portions when viewed in plan view. The term "average pitch" refers to the average value of pitches measured at any five positions.

The heights of the top surfaces 13a of the plurality of pad portions 13 may be uniform. Even if there are variations in the heights of the top surfaces 13a, the present manufacturing method enables appropriate soldering between the plurality of pad portions 13 and the plurality of central conductors 21. As illustrated in FIG. 3, in the case where variations exist among the top surfaces 13a, the lower limit of a height difference Hd among the top surfaces 13a of the plurality of pad portions 13 may be 2 μm or may be 4 μm. On the other hand, the upper limit of the height difference Hd may be 30 μm or may be 20 μm. Note that the term "height" of each of the top surfaces refers to the height of a central portion of the top surface in the width direction of the top surface, and the term "height difference" refers to the value obtained by subtracting the height of the top surface having the minimum height from the height of the top surface having the maximum height among the plurality of pad portions. In addition, the term "height difference" among the top surfaces may result from height variations in the pad portions themselves or from height variations in the overall structure of the printed circuit board, including the substrate.

### Insulated Wire

Each of the insulated wires 20 has a two-layer structure formed of one of the central conductors 21 and one of the insulating layers 22 laminated on the peripheral surface of the central conductor 21, and a portion of the central conductor 21 is exposed to the outside. The central conductor 21 is soldered to a corresponding one of the pad portions 13 at its portion exposed to the outside. The central conductor 21 may be exposed to the outside at a portion thereof projecting from a distal end portion of the insulating layer 22. Alternatively, the central conductor 21 may be exposed to the outside by removing a portion of the insulating layer 22 other than the distal end portion. In this case, a portion of the insulated wire 20 that is located further toward the distal side than the portion at which the central conductor 21 is exposed may be removed after the central conductor 21 has been soldered to the pad portion 13. By this removal, after being soldered to the pad portion 13, the central conductor 21 has a shape projecting from the distal end portion of the insulating layer 22. The length of the portion of the central conductors 21 projecting from the distal end portion of the insulating layer 22 may be, for example, 0.2 mm to 3.0 mm.

Note that the rest of the structure of the insulated wires 20 is not particularly limited as long as the insulated wires 20 include their central conductors 21. Each of the insulated wires 20 may include, for example, an outer conductor that is provided on the insulating layer 22, and may include an outer sheath that is provided on the outer conductor. In the case where each of the insulated wires 20 includes the outer conductor and the outer sheath, the insulated wire 20 may be a coaxial cable.

The central conductors 21 may each be, for example, a metal wire containing copper, a copper alloy, aluminum, an aluminum alloy or the like. The metal wire may be a single wire or may be a stranded wire. In the case where the metal wire is a stranded wire, the number of strands is not particularly limited and may be, for example, two to thirty.

The cross-sectional shape of each of the central conductors 21 perpendicular to the central axis of the central conductor 21 is not particularly limited, and may be, for example, a circular shape or a rectangular shape. In the case where the cross-sectional shape of the central conductor 21 is a circular shape, the central conductor 21 may be a round wire. In the case where the cross-sectional shape of the central conductor 21 is a rectangular shape, the central conductor 21 may be a square wire or a flat rectangular wire. Note that, in the present manufacturing method, in the case where the cross-sectional shape of each of the central conductors 21 is a circular shape, it may sometimes be easier to increase the contact areas among the central conductors 21, the pad portions 13, and the solder fillets.

The lower limit of the average diameter of each of the central conductors 21 may be 10 μm, may be 15 μm, or may be 20 μm from the standpoint of sufficiently increasing the contact areas between the central conductors 21 and the solder fillets. On the other hand, the upper limit of the average diameter may be 200 μm, may be 150 μm, may be 100 μm, or may be 50 μm from the standpoint of, for example, preventing the central conductors 21 from being excessively large with respect to the pad portions 13. In general, in the case where the average diameter of each of the central conductors 21 is the above-mentioned upper limit or less, if the heights of the top surfaces 13a of the plurality of pad portions 13 are not uniform, some of the central conductors 21 are likely to become separated from their respective pad portions 13 when the plurality of central conductors 21 are arranged with respect to the plurality of pad portions 13. In contrast, according to the present manufacturing method, even in the case where some of the central conductors 21 are separated from their respective pad portions 13 in the placing step S1, which will be described later, each of the central conductors 21 can be reliably soldered to the corresponding pad portion 13.

A preliminary solder portion (not illustrated) may be disposed at the peripheral surface of a portion of each of the central conductors 21, the portion being exposed to the outside. The preliminary solder portion may be formed by, for example, wetting the peripheral surface of the central conductor 21 with molten solder and causing the central conductor 21 to hold the solder. The type of solder included in the preliminary solder portion is not particularly limited and may be, for example, a lead-free solder such as SnAgCu alloy, SnZnBi alloy, SnAgInBi alloy, SnBi alloy, SnBiAg alloy, SnBiCuNi alloy, SnZn alloy, or InSnAg alloy. Note that, in the present manufacturing method, if the amount of solder included in the preliminary solder portions is sufficient, it is not necessary to provide the above-described solder portions 15.

Subsequently, each step of the present manufacturing method will be described.

### Placing Step

In the placing step S1, as illustrated in FIG. 2 and FIG. 3, the central conductors 21 are placed in a one-to-one correspondence with the pad portions 13 at each of which solder is disposed. The solder may be the solder portions 15 formed on the pad portions 13 or may be the preliminary solder portions disposed at the central conductors 21.

In the placing step S1, the central conductors 21 are aligned with the pad portions 13 such that the central axes of the pad portions 13 coincide with the central axes of their respective central conductors 21 when viewed in plan view. Note that the phrase "the central axes of the pad portions coincide with the central axes of their respective central conductors when viewed in plan view" is not limited to a case where the central axes completely coincide with each other, but includes a case where the central axes approximately coincide with each other.

In the placing step S1, the portions of the central conductors 21 that are exposed to the outside may be entirely placed on their respective pad portions 13, or the portions exposed to the outside may be partially placed on their respective pad portions 13. In the case where portions of the central conductors 21 are placed on their respective pad portions 13, the length of the portion of each of the central conductors 21 that is exposed to the outside may be, for example, about 1.1 times to about 1.5 times the long-side length of the corresponding pad portion 13.

In the placing step S1, the plurality of central conductors 21 may be collectively placed on the plurality of pad portions 13 after being fixed in place, by using a fixing member (not illustrated), so as to correspond to the pitch of the pad portions 13. The fixing member may be, for example, a tape or a sheet that fixes the plurality of insulated wires 20 in place in an aligned state. The fixing position of the tape or the sheet on each of the insulated wires 20 may be, for example, on the insulating layer 22, may be in a region of the central conductor 21 that does not overlap the pad portion 13, or may be in a region of the central conductor 21 that partially includes a portion of the central conductor 21 that overlaps the pad portion 13.

In the placing step S1, for example, all of the central conductors 21 may be brought into contact with the top surfaces 13a of their respective pad portions 13 (or with the solder portions 15 formed on the top surfaces 13a of their respective pad portions 13). In the present manufacturing method, it is possible that there are variations in the heights of the top surfaces 13a of the pad portions 13. In such a case, in the placing step S1, some of the central conductors 21 may be placed away from the top surfaces 13a of their respective pad portions 13 (or from the solder portions 15 formed on the top surfaces 13a of their respective pad portions 13). For example, when the above-mentioned fixing member is used, there may be a case where some of the central conductors 21 easily become separated from their respective pad portions 13. Even in such a case, the present manufacturing method enables appropriate soldering between the plurality of central conductors 21 and the plurality of pad portions 13.

### Pressing Step

In the pressing step S2, as illustrated in FIG. 4 to FIG. 7, the plurality of central conductors 21 are heated and pressed against the plurality of pad portions 13 by using a pressing jig 30. In the pressing step S2, the plurality of central conductors 21 may be pressed from the side opposite to the plurality of pad portions 13. In the pressing step S2, all of the central conductors 21 may be collectively pressed by the single pressing jig 30. In addition, in the pressing step S2, the solder (the solder portions 15 or the preliminary solder portions) disposed at the pad portions 13 is heated via the pressing jig 30, thereby melting the solder. The molten solder solidifies to form solder fillets 51.

Before describing the pressing step S2, the pressing jig 30 will be described first.

### Pressing Jig

As illustrated in FIG. 4 to FIG. 7, the pressing jig 30 includes a cushion portion 32 and a heat-conductive portion 33, in this order in a direction in which the pressing jig 30 presses the central conductors 21 (i.e., in the direction toward the central conductors 21). The pressing jig 30 is disposed such that the heat-conductive portion 33 is brought into direct contact with the plurality of central conductors 21. The pressing jig 30 may press the central conductors 21 as a result of a surface of the cushion portion 32 being pressed by a plate member (not illustrated), the surface being located on the side opposite to the side on which the heat-conductive portion 33 is disposed, or the pressing jig 30 may press the central conductors 21 as a result of being pressed against the central conductors 21 by reduced pressure or the like. Alternatively, the pressing jig 30 may press the central conductors 21 by pulling the pressing jig 30 toward the central conductors 21, or the pressing jig 30 may press the central conductors 21 as a result of the printed circuit board 10 being pressed in a state where the central conductors 21 have been placed.

### Cushion Portion

The cushion portion 32 is provided so as to undergo compression deformation (elastic deformation) when pressing the plurality of central conductors 21. The cushion portion 32 is formed to have such a size as to encompass the plurality of central conductors 21 and the plurality of pad portions 13 when viewed in plan view.

The cushion portion 32 has a layered structure. A main component of the cushion portion 32 may be, for example, rubber, a soft resin, or an elastomer. Examples of the above-mentioned rubber include silicone rubber and fluororubber. Examples of the above-mentioned soft resin include polyvinyl chloride, polyethylene, and ethylene-vinyl acetate copolymer. Examples of the above-mentioned elastomer include styrene-based thermoplastic elastomers and urethane-based thermoplastic elastomers. The cushion portion 32 may sometimes be heated by heat from the heat-conductive portion 33. In this case, it is preferable that the cushion portion 32 have heat resistance against the heat from the heat-conductive portion 33.

The cushion portion 32 may have a plurality of voids so as to be easily compressed and deformed to conform to the outer shapes of the plurality of central conductors 21.

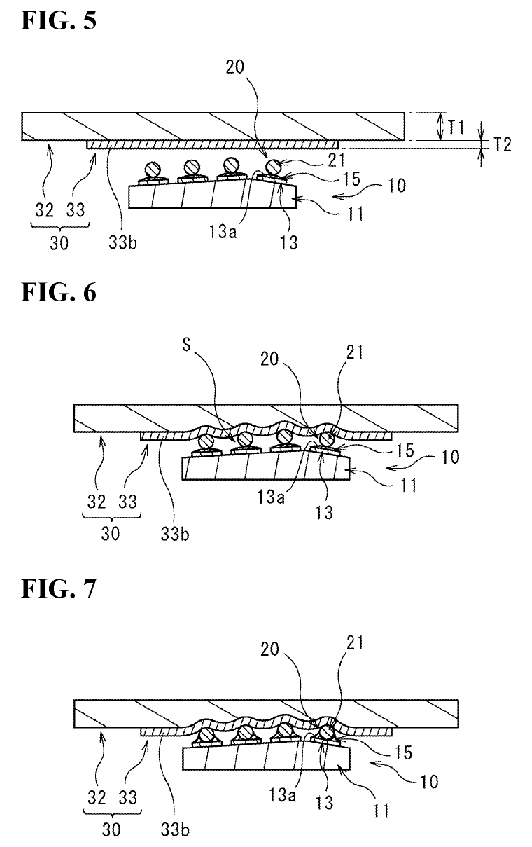

The lower limit of an average thickness T1 (see FIG. 5) of the cushion portion 32 may be 30 μm, may be 100 μm, or may be 200 μm from the standpoint of being capable of uniformly pressing the plurality of central conductors 21. On the other hand, the upper limit of the average thickness T1 may be 1000 μm or may be 800 μm from the standpoint of preventing the amount of deformation of the cushion portion 32 from becoming excessive, which may restrict a space in which the solder flows.

The cushion portion 32 includes, for example, any of the above-mentioned rubber, the above-mentioned soft resin, or the above-mentioned elastomer as a main component, and the average thickness T1 falls within the above-mentioned range, so that the plurality of central conductors 21 can be more easily pressed with uniform pressure.

The lower limit of the Young's modulus of the cushion portion 32 may be 1 MPa or may be 2.5 MPa from the standpoint of sufficiently pressing the plurality of central conductors 21. On the other hand, the upper limit of the Young's modulus may be 30 MPa or may be 5 MPa, from the standpoint of being capable of easily compressed and deformed to conform to the outer shapes of the plurality of central conductors 21. Note that, in the present disclosure, the term "Young's modulus" refers to a value measured in accordance with "tensile modulus" described in JIS K7161-1:2014.

### Heat-Conductive Portion

The heat-conductive portion 33 has thermal conductivity. The heat-conductive portion 33 also has flexibility that enables it to deform to conform to the outer shapes of the plurality of central conductors 21. The heat-conductive portion 33 has a layered structure. In the entire pressing jig 30, the heat-conductive portion 33 is positioned at the outermost layer that comes into direct contact with the plurality of central conductors 21. The heat-conductive portion 33 may be laminated directly on the cushion portion 32 or may be laminated on the cushion portion 32 with another layer interposed therebetween. In FIG. 4 to FIG. 7, the heat-conductive portion 33 is laminated directly on a surface of the cushion portion 32. The heat-conductive portion 33 may be fixed to the cushion portion 32 with an adhesive or the like.

The heat-conductive portion 33 presses the plurality of central conductors 21 while deforming to conform to the outer shapes of the plurality of central conductors 21, and in addition, the heat-conductive portion 33 heats and melts the solder disposed at each of the pad portions 13.

The heat-conductive portion 33 is formed to have such a size as to encompass the plurality of central conductors 21 and the plurality of pad portions 13 when viewed in plan view. The heat-conductive portion 33 may be laminated over the entire area of the cushion portion 32 when viewed in plan view or may be laminated only over a portion of the cushion portion 32. By reducing the area of the heat-conductive portion 33 that is laminated on the cushion portion 32, it is possible to prevent heat from the heat-conductive portion 33 from being excessively absorbed by the cushion portion 32, thereby preventing a reduction in the heating efficiency of each of the plurality of central conductors 21 and the heating efficiency of the solder disposed at the plurality of pad portions 13.

The heat-conductive portion 33 may have rigidity higher than that of the cushion portion 32. For example, the Young's modulus of the heat-conductive portion 33 may be greater than the Young's modulus of the cushion portion 32. In the present manufacturing method, if the cushion portion 32 comes into direct contact with the plurality of central conductors 21, there is a possibility that the cushion portion 32 may deform excessively to conform to the outer shapes of the plurality of central conductors 21 (the cushion portion 32 may deform so as to come into close contact with the plurality of central conductors 21), resulting in insufficient formation of a space in which the solder flows. However, since the heat-conductive portion 33 having rigidity higher than that of the cushion portion 32 is laminated on the cushion portion 32, it is possible to easily prevent the space in which the solder flows from becoming insufficient while deforming to conform to the outer shapes of the plurality of central conductors 21.

The heat-conductive portion 33 may be a film that contains a metal as a main component. According to this aspect, excessive deformation of the cushion portion 32 can be easily suppressed by the heat-conductive portion 33. As a result, it is possible to easily prevent the space in which the solder flows from becoming insufficient due to excessive deformation of the cushion portion 32. Examples of the above-mentioned metal include copper, aluminum, tungsten, gold, silver, molybdenum, beryllium, titanium, duralumin, and stainless steel.

In addition, the heat-conductive portion 33 may include, as, for example, a heat-conductive element, a carbon material such as carbon fiber, carbon nanotube, or graphene as a main component. The heat-conductive portion 33 may include crystals having a primary structure composed of zirconia, diamond, silicon carbide, alumina, boron nitride, or the like. Furthermore, the heat-conductive portion 33 may be a resin sheet that includes the heat-conductive element.

The upper limit of an average thickness T2 (see FIG. 5) of the heat-conductive portion 33 may be 500 μm or may be 100 μm from the standpoint of ensuring sufficient flexibility. On the other hand, the lower limit of the average thickness T2 may be 5 μm or may be 10 μm from the standpoint of easily heating the plurality of central conductors 21 and the solder disposed at the plurality of pad portions 13.

As illustrated in FIG. 4, the heat-conductive portion 33 includes a heating target region 33a that is to be heated by a heat source (not illustrated). More specifically, the heat-conductive portion 33 has the heating target region 33a, and a heating region 33b that heats the plurality of central conductors 21 and the solder disposed at the plurality of pad portions 13 by using heat transferred from the heating target region 33a. The heating region 33b overlaps the cushion portion 32 when viewed in plan view. In contrast, the heating target region 33a projects beyond the cushion portion 32 when viewed in plan view. Since the heating target region 33a is located at a position different from that of the heating region 33b in this manner, heat damage to the substrate 11 or other components when heating the heating target region 33a can be reduced. Since the pressing jig 30 has the heating target region 33a that projects beyond the cushion portion 32 when viewed in plan view, the heat-conductive portion 33 can be easily heated.

A direction in which the heating target region 33a projects when viewed in plan view is not particularly limited. However, the heating target region 33a may project in the axial direction of the plurality of central conductors 21. According to this aspect, equalization of the lengths of heat transfer paths to the plurality of central conductors 21 can be achieved. Therefore, the plurality of central conductors 21 and the solder disposed at the plurality of pad portions 13 can be uniformly heated via the heating region 33b. As a result, the plurality of central conductors 21 and their respective pad portions 13 can easily be soldered together with uniform bonding strength.

A width (a length in a direction perpendicular to the central axes of the plurality of central conductors 21) of the heating target region 33a may be equal to or greater than a width of the heating region 33b. According to this aspect, more uniform heating of the plurality of central conductors 21 and the solder disposed at the plurality of pad portions 13 is facilitated.

### Heat Source

The heat source that is used for heating the heating target region 33a is not particularly limited and may be, for example, hot air, a heater, or a lamp. In the case where the heat-conductive portion 33 is a conductor, the heat source may be one that generates Joule heat by being energized.

### Procedure

The procedure of the pressing step S2 will now be described.

First, in the pressing step S2, as illustrated in FIG. 4 and FIG. 5, the pressing jig 30 is placed on the plurality of central conductors 21. The positional relationship among the pressing jig 30, the plurality of central conductors 21, and the plurality of pad portions 13 is as described above.

Next, in the pressing step S2, as illustrated in FIG. 6, the plurality of central conductors 21 are pressed by the pressing jig 30. More specifically, in the pressing step S2, the plurality of central conductors 21 are pressed by the pressing jig 30 so as to come into close contact with the plurality of pad portions 13, in a state where a bottom surface (a surface that is located on the side opposite to the side on which the pad portions 13 are arranged) of the substrate 11 is supported by a support (not illustrated).

A load in the pressing step S2 may be, for example, 1 N to 40 N.

In the pressing step S2, the cushion portion 32 and the heat-conductive portion 33 are deformed to conform to the shapes of the plurality of central conductors 21. According to this aspect, the plurality of central conductors 21 and their respective pad portions 13 can be more reliably soldered together while the plurality of central conductors 21 are positioned with respect to the plurality of pad portions 13. In addition, according to this aspect, even in the case where there are variations in the heights of solder bonding surfaces (the top surfaces 13a) of the plurality of pad portions 13, the plurality of central conductors 21 and the plurality of pad portions 13 can be easily soldered together.

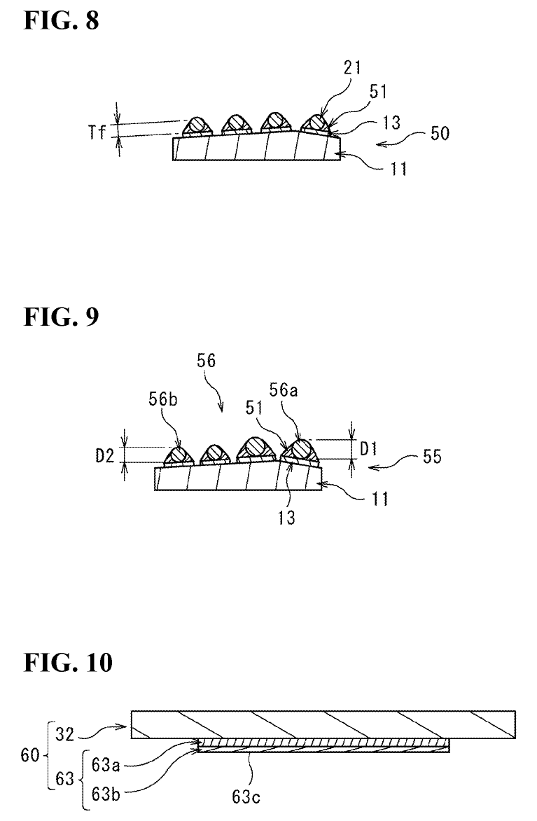

In the pressing step S2, by pressing with the pressing jig 30, the plurality of central conductors 21 are brought into close contact with the plurality of pad portions 13. At the time of the above operation, since the pressing jig 30 includes the heat-conductive portion 33 positioned at the outermost layer thereof, which comes into contact with the plurality of central conductors 21, a sufficient solder flow space S is formed in the vicinity of the plurality of central conductors 21 while deforming to conform to the outer shapes of the plurality of central conductors 21. In the pressing step S2, the plurality of central conductors 21 may be pressed by the pressing jig 30 while forming the solder flow space S such that a height Tf of each of the solder fillets 51 (see FIG. 8) is 0.6 times or more, 0.7 times or more, or 0.9 times or more the diameter of each of the central conductors 21.

In the pressing step S2, the plurality of central conductors 21 may be pressed in a non-adhesive manner by the heat-conductive portion 33. In other words, in the present manufacturing method, it is not necessary to provide, for example, either an adhesive layer or a pressure-sensitive adhesive layer at the outermost surface of the heat-conductive portion 33. According to this aspect, the height Tf of each of the solder fillets 51 can be more easily increased. Note that a surface of the heat-conductive portion 33 may be a solder-repellent surface, as will be described later. The term "solder-repellent surface" refers to a surface that prevents solder from adhering thereto.

In the pressing step S2, the heat-conductive portion 33 may be brought into contact with the substrate 11 or may not be brought into contact with the substrate 11. In the present manufacturing method, the heat-conductive portion 33 has appropriate rigidity (e.g., rigidity higher than that of the cushion portion 32), and thus, contact between the heat-conductive portion 33 and the substrate 11 can be easily avoided. In the present manufacturing method, the heat-conductive portion 33 is not brought into contact with the substrate 11 in the pressing step S2, so that the height Tf of each of the solder fillets 51 can be more easily increased. Note that, in the pressing step S2, the heat-conductive portion 33 may be configured not to come into contact with the plurality of pad portions 13 as well as the substrate 11.

In addition, in the pressing step S2, by heating the heat-conductive portion 33, the plurality of central conductors 21 and the solder disposed at the plurality of pad portions 13 are heated via the heat-conductive portion 33 as illustrated in FIG. 7. In the pressing step S2, the plurality of central conductors 21 and the solder may be heated after the central conductors 21 have been pressed. Alternatively, the plurality of central conductors 21 and the solder may be heated in parallel with the pressing of the plurality of central conductors 21, or the plurality of central conductors 21 may be pressed in a state where the plurality of central conductors 21 and the solder are heated.

In the pressing step S2, the heat-conductive portion 33 is in contact with all of the central conductors 21, and more specifically, the heat-conductive portion 33 is deformed to conform to the outer shapes of all the central conductors 21. Thus, in the pressing step S2, all of the central conductors 21 can be heated uniformly. This facilitates reduction in variations in the shapes of the solder fillets 51 for the plurality of central conductors 21.

In the pressing step S2, since the plurality of central conductors 21 are heated by the heat-conductive portion 33, the solder can be melted while the plurality of central conductors 21 are heated from their topmost portions (i.e., their portions that come into contact with the heat-conductive portion 33). As a result, in combination with the sufficient formation of the solder flow space S, the solder fillets 51 can be formed while causing the solder to flow toward the heat-conductive portion 33. Therefore, according to the present manufacturing method, the height Tf of each of the solder fillets 51 can be increased, and the contact areas among the plurality of central conductors 21, the plurality of pad portions 13, and the solder fillets 51 can be easily increased.

### Connector

In the pressing step S2, the plurality of central conductors 21 and their respective plurality of pad portions 13 are soldered together with the solder fillets 51, so that a connector 50 that is illustrated in FIG. 8 is obtained.

In the connector 50, the plurality of pad portions 13, which are arranged on the substrate 11, and the central conductors 21, which are arranged in a one-to-one correspondence with the pad portions 13, are soldered together with the solder fillets 51. In the connector 50, the central conductors 21 and their respective pad portions 13 are in close contact with each other. More specifically, each of the plurality of central conductors 21 is in close contact with the corresponding pad portion 13 to which the central conductor 21 is soldered. The specific structures of the substrate 11 and the plurality of pad portions 13 in the connector 50 are as described above for the printed circuit board 10. In addition, the specific structure of each of the central conductors 21 in the connector 50 is as described above for the insulated wires 20.

### Solder Fillet

The solder fillets 51 are formed on the pad portions 13 so as to solder the pad portions 13 to their respective central conductor 21 together.

The lower limit of the ratio of the height Tf of each of the solder fillets 51 to the diameter of each of the central conductors 21 may be 0.6, may be 0.7, or may be 0.9 from the standpoint of sufficiently increasing the contact areas between the central conductors 21 and the solder fillets 51. Since the connector 50 is manufactured by the present manufacturing method, the above-mentioned ratio can be easily increased. On the other hand, the upper limit of the above-mentioned ratio is not particularly limited and can be set to 1, in view of the fact that each of the central conductors 21 is pressed by the heat-conductive portion 33 in the pressing step S2.

In the connector 50, the above-mentioned ratio may be satisfied for all of the central conductors 21. Since the connector 50 is manufactured by the present manufacturing method, the above-mentioned ratio can be satisfied for all of the central conductors 21.

### Modifications

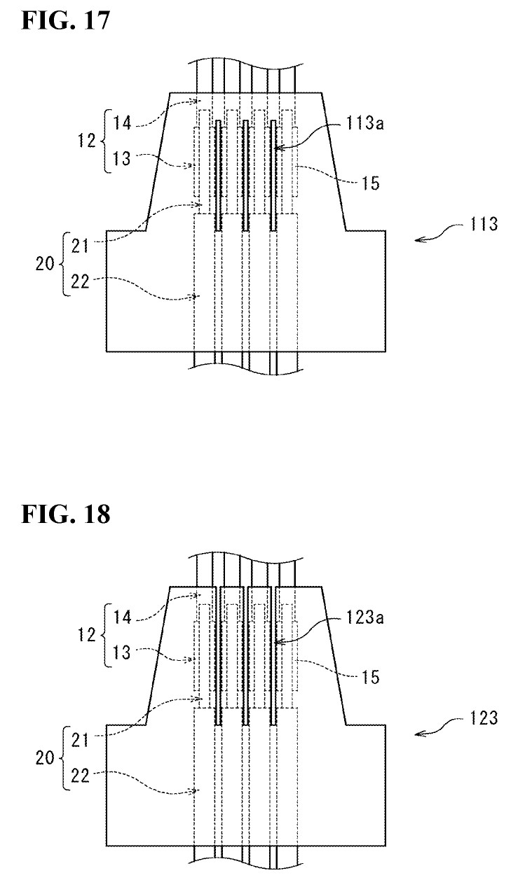

Modifications of the connector 50 and the pressing jig 30 will be described with reference to FIG. 9 to FIG. 18.

### Modified Example of Connector

In a connector 55 that is illustrated in FIG. 9, a plurality of central conductors 56 are arranged in a one-to-one correspondence with the plurality of pad portions 13, which are arranged on the substrate 11, and soldered to their respective pad portions 13 with the solder fillets 51.

The connector 55 includes, as the plurality of central conductors 56, one or a plurality (two are illustrated in FIG. 9 as an example) of first central conductors 56a each of which has a first average diameter D1, and one or a plurality (two are illustrated in FIG. 9 as an example) of second central conductors 56b each of which has a second average diameter D2 smaller than the first average diameter D1. The connector 55 may have a structure the same as that of the connector 50 illustrated in FIG. 8, except that the connector 55 includes the one or the plurality of first central conductors 56a and the one or the plurality of second central conductors 56b as the plurality of central conductors 56.

According to the present manufacturing method, even in a case where the plurality of central conductors 56 include central conductors having different diameters (the first and second central conductors 56a and 56b), the plurality of pad portions 13 and the plurality of central conductors 56 can be easily soldered together. Note that, although the first and second central conductors 56a and 56b are illustrated in FIG. 9 as the central conductors having different diameters, the connector 55 may further include a central conductor that has a diameter different from each of the diameters of the first and second central conductors 56a and 56b.

The first average diameter D1 and the second average diameter D2 are not particularly limited and may each fall within, for example, the same range as that of the average diameter of the central conductors 21 in the first embodiment, which has been described above.

The lower limit of the difference (D1 - D2) between the first average diameter D1 and the second average diameter D2 may be set depending on, for example, an intended application of the first and second central conductors 56a and 56b and may be, for example, 5 μm or may be 10 μm. On the other hand, the upper limit of the difference (D1 - D2) may be, for example, 150 μm or may be 100 μm from the standpoint of reliably soldering the plurality of pad portions 13 and the plurality of central conductors 56 together.

### Modifications of Pressing Jig

### First Modification

A pressing jig 60 that is illustrated in FIG. 10 includes the cushion portion 32 and a heat-conductive portion 63 in this order in a direction in which the pressing jig 60 presses a plurality of central conductors. The cushion portion 32 of the pressing jig 60 may have a structure similar to that of the cushion portion 32 in the first embodiment. Accordingly, only the heat-conductive portion 63 will be described below.

### Heat-Conductive Portion

The heat-conductive portion 63 includes a solder-repellent layer 63b that comes into contact with the plurality of central conductors. More specifically, the heat-conductive portion 63 has a two-layer structure formed of a base layer 63a and the solder-repellent layer 63b laminated on the base layer 63a. Note that, in FIG. 10, the solder-repellent layer 63b is disposed on only one side of the base layer 63a. However, in the present disclosure, the solder-repellent layer 63b may be disposed on both sides of the base layer 63a. The solder-repellent layer 63b has a solder-repellent surface 63c that comes into contact with the plurality of central conductors. In other words, the heat-conductive portion 63 has the solder-repellent surface 63c that comes into contact with the plurality of central conductors.

The specific structure of the base layer 63a of the heat-conductive portion 63 may have a structure similar to that of the heat-conductive portion 33 in the first embodiment. The base layer 63a (i.e., the heat-conductive portion 33 in the first embodiment) may have insufficient solder repellency depending on its material. In this case, in the pressing step S2 described above, the solder may sometimes adhere to the heat-conductive portion 63, thereby making it difficult to form desired solder fillets. In contrast, since the heat-conductive portion 63 has the solder-repellent surface 63c, the solder can be prevented from being bonded to the heat-conductive portion 63. As a result, the plurality of central conductors and a plurality of pad portions can be easily and reliably soldered together.

The solder-repellent layer 63b is disposed in a region where it comes into direct contact with the plurality of central conductors. The solder-repellent layer 63b may have high thermal conductivity. The solder-repellent layer 63b may be made of a material such as a heat-resistant resin or a metal coating film that is different from that of the base layer 63a. Alternatively, the solder-repellent layer 63b may be formed by a coating film of the heat-conductive portion 63 itself.

Examples of the above-mentioned heat-resistant resin include polyimide, polyethylene terephthalate, polyethylene naphthalate, polyphenylene ether, polytetrafluoroethylene, polyamide-imide, liquid crystal polyester, polyurethane, polyvinyl chloride, polyvinyl acetal, perfluoroalkoxy alkane, polyetheretherketone, polybenzimidazole, and wholly aromatic polyester. The heat-resistant resin may be formed, for example, into a film and may be laminated onto the base layer 63a by baking. In the case of using the above-mentioned heat-resistant resin as the material for the solder-repellent layer 63b, one example of a specific combination of the solder-repellent layer 63b, the base layer 63a, and the cushion portion 32 is a multilayer structure formed of a polyimide layer, a copper foil layer, and a silicone rubber layer.

Examples of the above-mentioned metal film include coating films, oxide films, nitride films, or fluoride films containing aluminum, titanium, tungsten, stainless steel, silicon, tantalum, molybdenum, or alloys thereof. The above-mentioned metal coating film can be formed by, for example, sputtering, chemical vapor deposition (CVD), or plating.

In the case where the solder-repellent layer 63b is made of a material different from that of the base layer 63a, the upper limit of the average thickness of the solder-repellent layer 63b may be, for example, 50 μm or may be 25 μm from the standpoint of preventing a reduction in the heating efficiency of the plurality of central conductors and the solder disposed at the plurality of pad portions. On the other hand, the lower limit of the average thickness is not particularly limited as long as a sufficient solder-repellent effect is obtained and may be, for example, 50 nm, may be 1 μm, or may be 5 μm.

Examples of the coating film of the heat-conductive portion 63 itself include an oxide film, a nitride film, or a fluoride film of the metal forming the base layer 63a. As one example of a specific combination of the solder-repellent layer 63b, the base layer 63a, and the cushion portion 32 is a multilayer structure formed of an aluminum oxide layer (Al₂O₃ layer), an aluminum foil layer, and a silicone rubber layer.

In the case where the solder-repellent layer 63b is formed of the coating film of the heat-conductive portion 63 itself, the average thickness of the solder-repellent layer 63b may be, for example, 1 nm to 10 nm, may be 1 nm to 5 nm, or may be 1 nm to 3 nm.

### Second Modification

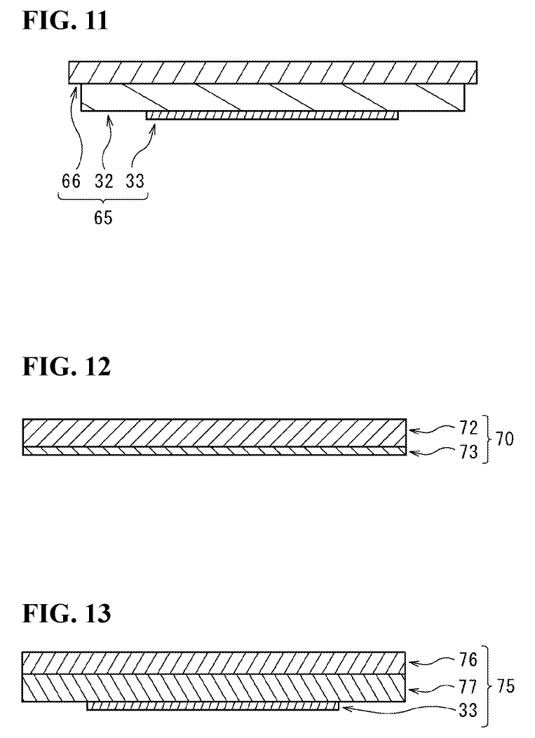

A pressing jig 65 that is illustrated in FIG. 11 includes a pressing portion 66, the cushion portion 32, and the heat-conductive portion 33 in this order in a direction in which the pressing jig 65 presses a plurality of central conductors. In other words, the pressing jig 65 includes the pressing portion 66 that is disposed on a surface of the cushion portion 32, the surface being located on the side opposite to the side on which the heat-conductive portion 33 is disposed. The pressing jig 65 may have a structure similar to that of the pressing jig 30 in the first embodiment except that the pressing jig 65 includes the pressing portion 66. Accordingly, only the pressing portion 66 will be described below.

### Pressing Portion

The pressing portion 66 is formed to have a size such that it encompasses the plurality of central conductors and a plurality of pad portions when viewed in plan view. The pressing portion 66 is, for example, plate-shaped. The pressing portion 66 is a rigid member. The pressing portion 66 supports the cushion portion 32 and the heat-conductive portion 33 and has a function of pressing the cushion portion 32 and the heat-conductive portion 33 against the plurality of central conductors. Examples of the material of the pressing portion 66 include metals and engineering plastics.

The pressing portion 66 may be laminated directly on the cushion portion 32 or may be laminated on the cushion portion 32 with another layer interposed therebetween. In FIG. 11, the pressing portion 66 is laminated directly on the cushion portion 32. The pressing portion 66 may be fixed to the cushion portion 32 with an adhesive or the like.

Since the pressing jig 65 includes the pressing portion 66, the pressing jig 65 can easily and reliably press the cushion portion 32 and the heat-conductive portion 33 against the plurality of central conductors.

### Third Modification

A pressing jig 70 that is illustrated in FIG. 12 includes a cushion portion 72 and a heat-conductive portion 73 in this order in a direction in which the pressing jig 70 presses a plurality of central conductors. In the pressing jig 70, the cushion portion 72 and the heat-conductive portion 73 are integrally formed. More specifically, the cushion portion 72 and the heat-conductive portion 73 are constituted by a single resin-molded body. The heat-conductive portion 73 is formed by incorporating a heat-conductive element into a portion of the resin-molded body.

Since the heat-conductive portion 73 is formed by incorporating a heat-conductive element into a portion of the resin-molded body, the heat-conductive portion 73 can have rigidity higher than that of the cushion portion 72. Thus, the pressing jig 70 is likely to prevent the solder flow space from becoming insufficient while deforming to conform to the outer shapes of the plurality of central conductors.

### Fourth Modification

A pressing jig 75 that is illustrated in FIG. 13 includes a pressing portion 76, a cushion portion 77, and the heat-conductive portion 33 in this order in a direction in which the pressing jig 75 presses a plurality of central conductors. The heat-conductive portion 33 is not particularly limited and may have a structure similar to that of the heat-conductive portion 33 in the first embodiment, and thus, the description thereof will be omitted.

In the pressing jig 75, the pressing portion 76 and the cushion portion 77 are integrally formed. More specifically, the pressing portion 76 and the cushion portion 77 are constituted by a single resin-molded body. The pressing portion 76 and the cushion portion 77 are formed by varying the hardness (e.g., Young's modulus) of the above-mentioned resin-molded body in the direction in which the plurality of central conductors are pressed. In other words, in the present disclosure, the pressing portion 76 and the cushion portion 77 may be defined on the basis of a difference in Young's modulus. The Young's modulus of the resin-molded body may gradually decrease in the direction in which the plurality of central conductors are pressed. The hardness of the resin-molded body may be varied by, for example, forming a gradient in the amounts of components contained in the resin-molded body.

The Young's modulus of the cushion portion 77 may fall within a range similar to that of the cushion portion 32 in the first embodiment.

As for the lower limit of the Young's modulus of the pressing portion 76, any value greater than the Young's modulus of the cushion portion 77 may be employed. However, from the standpoint of sufficiently pressing the plurality of central conductors 21, the lower limit may be 10 MPa or may be 30 MPa.

Note that, in FIG. 13, the pressing portion 76 and the cushion portion 77 are integrally constituted by a single resin-molded body. However, in the present disclosure, the pressing portion, the cushion portion, and the heat-conductive portion may be integrally constituted by a single resin-molded body.

### Fifth Modification

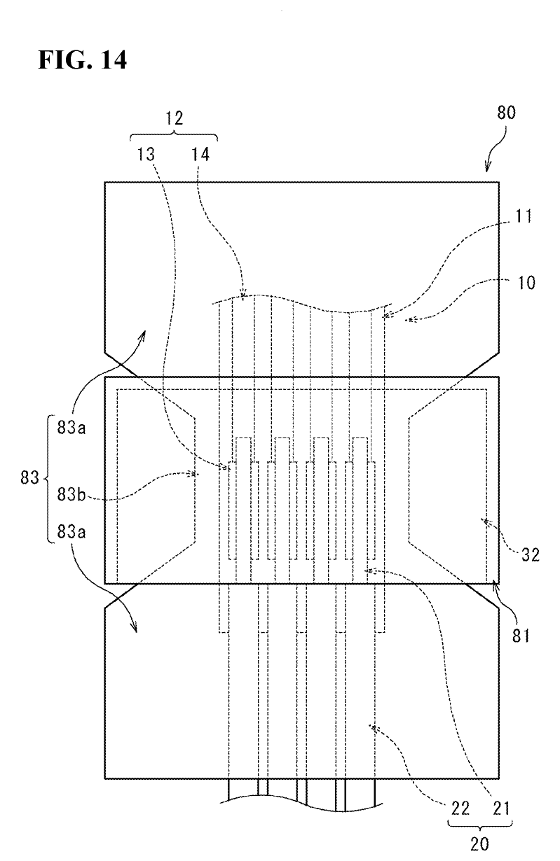

A pressing jig 80 that is illustrated in FIG. 14 includes a pressing portion 81, the cushion portion 32, and a heat-conductive portion 83 in this order in a direction in which the pressing jig 80 presses the plurality of central conductors 21. The heat-conductive portion 83 includes heating target regions 83a each of which projects beyond the cushion portion 32 when viewed in plan view. The heating target regions 83a project in the axial direction of the plurality of central conductors 21. More specifically, the heating target regions 83a project from both sides of the heating region 83b in the axial direction of the plurality of central conductors 21. The pressing jig 80 may have a structure similar to that of the pressing jig 30 in the first embodiment except that the heating target regions 83a project from both sides of the heating region 83b in the axial direction of the plurality of central conductors 21 and that the pressing jig 80 includes the pressing portion 81. Note that the pressing jig 80 illustrated in FIG. 14 may have a structure that does not include the pressing portion 81.

In the pressing jig 80, since the heating target regions 83a project from both sides of the heating region 83b, the temperature ramp-up rate and the maximum attainable temperature of the plurality of central conductors 21 can be increased. As a result, even in the case where the diameters of the central conductors 21 are large, the plurality of central conductors 21 and the plurality of pad portions 13 can be easily soldered together. In addition, since the heating target regions 83a project from both sides of the heating region 83b, uneven heating of the plurality of central conductors 21 and the like can be more easily reduced.

### Sixth Modification

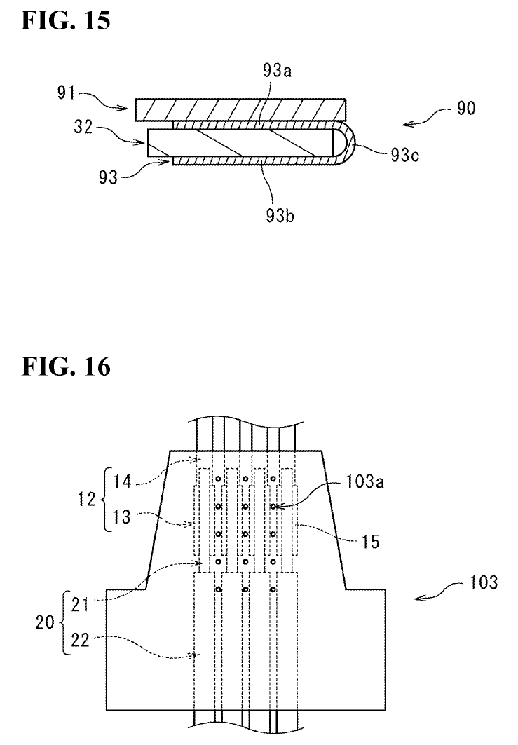

A pressing jig 90 that is illustrated in FIG. 15 includes a pressing portion 91, the cushion portion 32, and a heat-conductive portion 93 in this order in a direction in which the pressing jig 90 presses a plurality of central conductors. More specifically, the pressing jig 90 includes the pressing portion 91, the cushion portion 32, and a heating region 93b, which will be described later, in this order in the direction in which the pressing jig 90 presses the plurality of central conductors. The cushion portion 32 of the pressing jig 90 may have a structure similar to that of the cushion portion 32 in the first embodiment. Accordingly, only the pressing portion 91 and the heat-conductive portion 93 will be described below.

### Pressing Portion

The pressing portion 91 functions as a heat source for the heat-conductive portion 93. In other words, the pressing jig 90 heats the heat-conductive portion 93 via the pressing portion 91. Except for heating of the heat-conductive portion 93, the structure of the pressing portion 91 is similar to that of the pressing portion 66 in the second modification. Note that means for heating the pressing portion 91 may be similar to that used for the heating target region 33a in the first embodiment.

### Heat-Conductive Portion

The heat-conductive portion 93 is bent so as to be in contact with the pressing portion 91. In addition, the heat-conductive portion 93 is provided so as to be heated by the heat from the pressing portion 91. More specifically, the heat-conductive portion 93 includes the heating region 93b that is positioned at the outermost layer so as to come into direct contact with the plurality of central conductors and a heating target region 93a that is bent from the heating region 93b so as to be positioned between the pressing portion 91 and the cushion portion 32. The heat-conductive portion 93 is configured such that the heating target region 93a is heated by the pressing portion 91 and that the heat is transferred from the heating target region 93a to the heating region 93b to heat the plurality of central conductors and the like. The material of the heat-conductive portion 93 may be similar to that of the heat-conductive portion 33 in the first embodiment. In addition, the heat-conductive portion 93 may have a solder-repellent surface that comes into contact with the plurality of central conductors.

According to the present manufacturing method, since the heat-conductive portion 93 is bent so as to be in contact with the pressing portion 91 and is heated by the heat from the pressing portion 91, the installation area of an apparatus can be reduced, thereby achieving cost reduction. In addition, in the present manufacturing method, since the heat-conductive portion 93 is bent so as to sandwich the cushion portion 32, the cushion portion 32 can be heated simultaneously with heating of the heat-conductive portion 93. As a result, the amount of heat that escapes from the heat-conductive portion 93 to the cushion portion 32 can be reduced, making it easier to increase the temperature ramp-up rate and the maximum attainable temperature of the plurality of central conductors. Therefore, according to the present manufacturing method, the manufacturing efficiency of the connector can be improved.

A bent portion 93c of the heat-conductive portion 93 (the bending axis of the bent portion 93c) may extend in a direction intersecting the central axes of the plurality of central conductors or may extend in a direction orthogonal to the central axes of the plurality of central conductors. According to this aspect, it becomes easier to achieve equalization of the lengths of heat transfer paths to the plurality of central conductor.

### Seventh Modification

As illustrated in FIG. 16 to FIG. 18, heat-conductive portions 103, 113, and 123 may each have holes 103a, slits 113a, or cutouts 123a in a region (i.e., heating region) thereof that is located above the cushion portion.

In each of the heat-conductive portions 103, 113, and 123, the plurality of holes 103a, the plurality of slits 113a, or the plurality of cutouts 123a are arranged so as to correspond to gaps between the plurality of central conductors 21. The plurality of holes 103a, the plurality of slits 113a, or the plurality of cutouts 123a may be arranged along the axial direction of the central conductors 21 at the gaps between the plurality of central conductors.

Each of the heat-conductive portions 103, 113, and 123 becomes more deformable by having the holes 103a, the slits 113a, or the cutouts 123a. As a result, for example, by arranging the plurality of holes 103a, the plurality of slits 113a, or the plurality of cutouts 123a such that they correspond to the gaps between the plurality of central conductors 21, it becomes easier to deform the heat-conductive portions 103, 113, and 123 so as to conform to the outer shapes of the plurality of central conductors 21, while appropriately heating and pressing the plurality of central conductors 21. Therefore, for example, by increasing the thickness of each of the heat-conductive portions 103, 113, and 123, the temperature ramp-up rate and the maximum attainable temperature of the plurality of central conductors 21 can be increased.

### Other Embodiments

The embodiments disclosed herein are to be considered as illustrative in all respects and not restrictive. The scope of the present disclosure is not limited to the configurations of the above-described embodiment, but rather is defined by the claims, and is intended to include all modifications equivalent in meaning and scope to the claims.

For example, the specific structure of the above-described pressing jig is not limited to that of the above-described embodiment. It is only necessary for the above-described pressing jig to include the cushion portion and the heat-conductive portion in this order in the direction in which the pressing jig presses the plurality of central conductors and may further include other components or layers. In addition, in the above-described pressing jig, when the heat-conductive portion is heated by the heat from the pressing portion, it is only necessary for the heat-conductive portion to be bent so as to be in contact with the pressing portion, and the heat-conductive portion does not need to be sandwiched between the pressing portion and the cushion portion.

What is claimed is:

1. A method of manufacturing a connector in which a plurality of central conductors each exposed at an end portion of an insulated wire are soldered, in a one-to-one correspondence, to a plurality of connectable portions arranged side by side on a substrate, the method comprising:
placing the plurality of central conductors in a one-to-one correspondence with the plurality of connectable portions at each of which solder is disposed; and
pressing the plurality of central conductors placed in the placing against the plurality of connectable portions,
wherein, in the pressing, the plurality of central conductors are heated and pressed by using a pressing jig, and
wherein the pressing jig includes a cushion portion and a heat-conductive portion sequentially in a direction in which the pressing jig presses the plurality of central conductors.

2. The method of manufacturing the connector according to claim 1,
wherein, in the pressing, the cushion portion and the heat-conductive portion are deformed to conform to shapes of the plurality of central conductors.

3. The method of manufacturing the connector according to claim 1,
wherein the pressing jig further includes a pressing portion disposed on a surface of the cushion portion, the surface being located on a side opposite to the heat-conductive portion.

4. The method of manufacturing the connector according to claim 1,
wherein, in the pressing, the plurality of central conductors are pressed in a non-adhesive manner by the heat-conductive portion.

5. The method of manufacturing the connector according to claim 1,
wherein, in the pressing, the heat-conductive portion is not brought into contact with the substrate.

6. The method of manufacturing the connector according to claim 1,
wherein the heat-conductive portion includes a heating target region projecting beyond the cushion portion in plan view.

7. The method of manufacturing the connector according to claim 6,
wherein the heating target region projects in an axial direction of the plurality of central conductors.

8. The method of manufacturing the connector according to claim 3,
wherein the heat-conductive portion is bent to be in contact with the pressing portion, and
wherein the heat-conductive portion is heated by heat from the pressing portion.

9. The method of manufacturing the connector according to claim 1,
wherein the heat-conductive portion has a solder-repellent surface configured to come into contact with the plurality of central conductors.

10. The method of manufacturing the connector according to claim 1,
wherein the cushion portion contains rubber, a soft resin, or an elastomer as a main component, and
wherein an average thickness of the cushion portion is 30 µm to 1000 µm.

11. The method of manufacturing the connector according to claim 1,
wherein the heat-conductive portion is a film containing a metal as a main component.

12. The method of manufacturing the connector according to claim 1,
wherein the heat-conductive portion has a hole, a slit, or a notch in a region located above the cushion portion.

13. The method of manufacturing the connector according to claim 1,
wherein the connector includes, as the plurality of central conductors,
one or a plurality of first central conductors each having a first average diameter, and
one or a plurality of second central conductors each having a second average diameter smaller than the first average diameter.
